(19) United States
(12) Patent Application Publication
(10) Pub. No.: US 2011/0279459 A1
(43) Pub. Date: Nov. 17, 2011

(54) System and Method for Graphically Enriching Promotional Messages Delivered to Handheld Communication Devices

(75) Inventor: Gregor Hohpe, San Francisco, CA (US)

(73) Assignee: Google, Inc.

(21) Appl. No.: 12/781,444

(22) Filed: May 17, 2010

(51) Int. Cl. G06T 11/00; G06F 15/16

(52) U.S. Cl. 345/467; 709/206

(57) ABSTRACT

Graphically enriching a promotional message delivered to a mobile communication device is described. For example, a mobile content server may receive the promotional message to be delivered to the mobile communication device. The mobile content server may determine content included in the received promotional message and identify at least one graphic associated with the determined content. The identified graphic may convey the relevance of the promotional message. The mobile content server may generate a graphically-enriched promotional message that includes the determined content and the identified graphic and communicate the graphically-enriched promotional message to the mobile communication device.

### FIELD OF THE INVENTION

The disclosure relates to communicating promotional messages to mobile communication devices and more particularly to graphically enriching a promotional message to be displayed at a mobile communication device.

### BACKGROUND OF THE INVENTION

Promotional messages such as advertisements, coupons, and other promotional content, should enable a target audience to quickly determine the relevance of the promotional messages. In other words, a recipient of a promotional message should be able to quickly determine whether the recipient is interested in the promotional message. Typically, the recipient must review the content of the promotional message to determine the relevance of the promotional message. The content may include text, words, colors, and/or other information that conveys the promotional message.

In conventional systems, the content does not enable a recipient of the promotional message to quickly determine its relevance. For example, the content may include words that must be read by the recipient in order to determine the relevance of the promotional message. However, given the short time period and/or small display screen with which the recipient may view the promotional message, the recipient may fail to take the time to read or otherwise notice the promotional message.

In general, the amount of time and/or display space the promotional message may have to convey such relevance may be limited. For example, a user viewing a website may navigate away from the website at any time. In another example, an operator of a mobile communication device may be travelling, talking on the phone, or otherwise performing other distracting activities. Furthermore, mobile communication devices typically have smaller screen sizes than other computing devices, limiting the display area in which to convey the promotional message. Thus, in these and other instances, the promotional message should be presented such that the recipient is able to quickly determine the relevance of the promotional message.

In some conventional systems, a promotional message may include graphical images, including images or other graphical content, designed to capture the attention of the recipient. However, in these systems, the advertiser or other marketer includes such graphical images in the promotional message. In other words, when designing the promotional message, the advertiser includes certain graphical images in order to capture the attention of the recipient. However, these graphical images do not necessarily assist the recipient with determining the relevance of the promotional message. In these systems, the promotional message is delivered to the recipient as designed by the advertiser. For example, an advertiser or other promoter may create a promotional message “buy one product, get one free.” In an effort to capture the attention of the recipient, the advertiser may stress or otherwise graphically convey the word “free” instead of the product being promoted. Thus, in these conventional systems, the promotional message is presented as-designed by the advertiser in order to attract attention to the promotional message rather than inform the recipient of the relevance of the promotional message.

What is needed are improved systems and methods for graphically enriching promotional messages displayed at mobile communication devices so that operators of mobile communication devices may quickly ascertain the relevance of the promotional messages. These and other problems exist.

### SUMMARY OF THE INVENTION

Various systems, computer program products, and methods for graphically enriching promotional messages displayed at a mobile communication device are described herein. For example, a mobile content server may request and receive a promotional message such as an advertisement, coupon, and/or other promotional information, from a promotional message serving system. The promotional message as received is designed by an advertiser or other promoter wishing to sell goods and/or services. Thus, the promotional message is typically designed to attract attention rather than to convey relevance to a recipient.

In some implementations of the invention, the mobile content server may determine content of the promotional message. For example, the promotional message may be parsed to identify text, words, colors, or other content included in the promotional message. The content may include, for example, “buy one product, get one free” and/or other content that conveys the promotional message. In this example, the advertiser may wish to emphasis “free” merely to capture the attention of the recipient without conveying the relevance of the promotional message (e.g., the recipient may not be interested in the particular product).

In some implementations of the invention, the mobile content server may identify a graphic based on the determined content. For example, the mobile content server may generate a match between the parsed words and match words that are associated with particular graphics. Thus, an associated graphic for a particular match may be identified. In the foregoing example, the mobile content server may identify a graphic associated with the product being promoted in the promotional message to convey the relevant subject matter of the promotional message. In some implementations of the invention, the mobile content server may generate a graphically enriched promotional message. For example, the mobile content server may combine the determined content with the identified graphic to provide the graphically enriched promotional message.

In some implementations of the invention, the identified graphic may be an emoji or similar graphic. Emoji may be easily recognized and express common activities such as dining out, drinking, travelling, shopping, and/or other common activities. Thus, emoji may be used to express relevance of a wide range of subject matter in promotional messages.

In some implementations of the invention, the mobile content server may communicate the graphically enriched promotional message to a mobile communication device. In this manner, the recipient of the graphically enriched promotional message, such as an operator of the mobile communication device, may receive graphics identified by mobile content server that convey relevance of the promotional message rather than graphics that are primarily designed/selected by advertisers to capture attention.

### BRIEF DESCRIPTION OF THE DRAWINGS

FIG. 1 is a block diagram illustrating a system for graphically enriching a promotional message to be displayed at mobile communication device, according to various implementations of the invention.

FIG. 2 is a data flow diagram illustrating process relationships in a system for graphically enriching a promotional message to be displayed at a mobile communication device, according to various implementations of the invention.

FIG. 3 is a block diagram illustrating a process of identifying a graphic based on match items and content parsed from a promotional message, according to various implementations of the invention.

FIG. 4 is a block diagram illustrating a process of identifying a graphic based on match classes and content parsed from a promotional message, according to various implementations of the invention.

FIGS. 5A and 5B are diagrams illustrating graphically enriched promotional messages as displayed on a display screen, according to various implementations of the invention.

FIG. 6 is a process diagram illustrating a process of graphically enriching a promotional message to be displayed at a mobile communication device, according to various implementations of the invention.

### DETAILED DESCRIPTION OF THE INVENTION

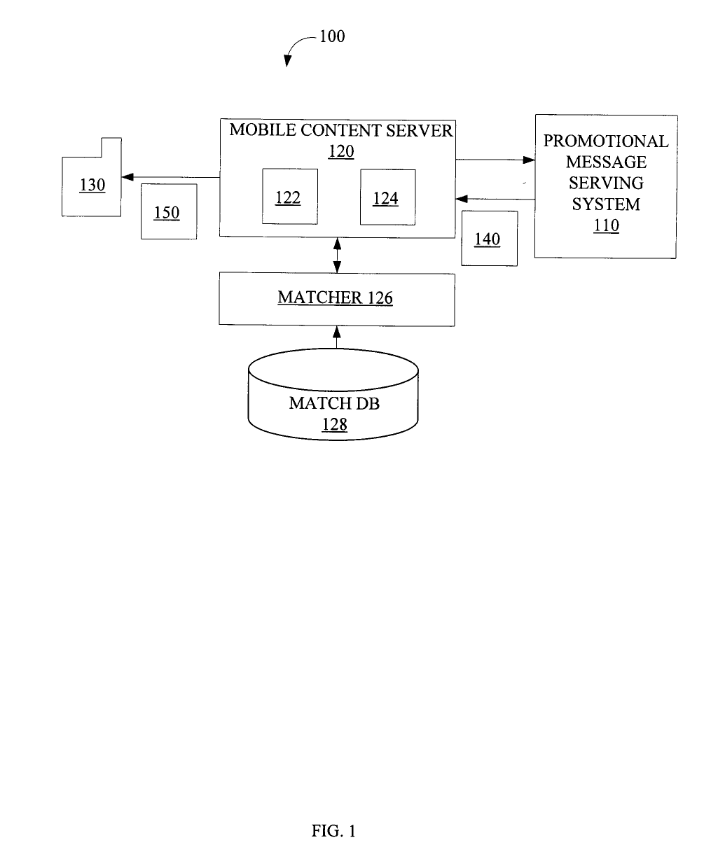

FIG. 1 is a block diagram illustrating a system 100 for graphically enriching a promotional message 140 to be displayed at a mobile communication device 130, according to various implementations of the invention. According to various implementations of the invention, system 100 may process promotional message 140 to generate graphically enriched promotional message 150.

Promotional message 140 may include, for example, an advertisement, a coupon, and/or other marketing content. Promotional message 140 may include content in various types of formats such as text, image, video, audio, other formats suitable to convey promotional message 140, and/or any combination of formats. In some implementations of the invention, promotional message 140 includes only words formed from text. In some implementations, promotional message 140 includes a Short Message Service message (i.e., a text message).

In some implementations of the invention, system 100 may determine the content presented in promotional message 140 and identify a relevant graphic based on the determined content. The graphic may convey the relevance of the content to the recipient in a graphical manner. In some implementations of the invention, the graphic includes an emoji, a graphical image, symbol, character, or other graphic that can convey relevance of promotional message 140. In some implementations of the invention, the emoji may include compact pictograms that are easily recognizable. In some implementations of the invention, the emoji may be one of many predefined emojis that are standardized in certain devices such as mobile communication device 130. For example, mobile communication device 130 may include a plurality of predefined emojis stored on a memory (not otherwise illustrated in FIG. 1) of mobile communication device 130. Emoji may express common activities such as dining out, drinking, travel, shopping, and/or other common activities or services. Thus, emoji may be used to express relevance of a wide range of subject matter in promotional messages.

In some implementations of the invention, based on the determined content and the identified graphic, system 100 may generate graphically enriched promotional message 150. In some implementations of the invention, graphically enriched promotional message 150 may be communicated to mobile communication device 130 (illustrated in FIG. 1 as mobile communication devices 130A, 130B, 130N).

According to various implementations of the invention, system 100 may include a promotional message serving system 110, a mobile content server 120, a matcher 126, a match database 128. System 100 may include or otherwise communicate with mobile communication device 130, and/or other components. Mobile communication device 130 may include a mobile device such as a cellular telephone, a personal digital assistant, a tablet computing device, and/or other mobile communication device on which promotional message 140 and/or graphically enriched promotional message 150 can be displayed. However, as would be appreciated, instead of or in addition to mobile communication device 130, various functions described herein may be applied to other devices such as a desktop computer, a laptop computer, or other computing devices that may or may not be portable. For example, the functions described herein may be used to graphically enrich promotional messages delivered to recipients via E-mail applications (including web-based E-mail), Internet search results, and/or other interfaces that can be used to communicate promotional messages.

In some implementations of the invention, promotional message serving system 110, mobile content server 120, matcher 126, match database 128, and mobile communication device 130 may be coupled to one another via a network (not otherwise illustrated in FIG. 1). The network may include a Local Area Network, a Wide Area Network, a cellular communications network, a Public Switched Telephone Network, and/or other network or combination of networks.

According to various implementations of the invention, mobile content server 120 may receive a mobile request from mobile communication device 130. In some implementations of the invention, the mobile request may be related to: one or more query terms for a search; an email; a gaming application; a website; and/or other request originating from mobile communication device 130. In response to the mobile request, mobile content server 120 may request promotional message 140 from promotional message serving system 110. Based on the request, promotional message serving system 110 may identify promotional message 140 to be displayed at mobile communication device 130. Mobile content server 120 may receive promotional message 140 from promotional message serving system 110. In some implementations of the invention, mobile content server 120 may graphically enrich promotional message 140 prior to communicating the message to mobile communication device 130. In other words, mobile content server 120 may perform various processing on promotional message 140 to generate graphically enriched promotional message 150.

In some implementations of the invention, the various processing may include a determination of content included in promotional message 140. Based on the determined content, mobile content server 120 may identify a graphic that may be used to graphically enrich promotional message 140 to generate graphically enriched promotional message 150. Graphically enriched promotional message 150 includes instructions and/or other formatting information that when executed at mobile communication device 130 generates a display that includes the contents of graphically enriched promotional message 150.

In some implementations of the invention, mobile content server 120 “graphically enriches” promotional message 140 by including the identified graphic (which was not present in promotional message 140 prior to graphical enrichment) into promotional message 140, thereby generating graphically enriched promotional message 150. In other words, mobile content server 120 may insert the identified graphic into promotional message 140 while otherwise substantially maintaining the original format of promotional message 140. In some implementations of the invention, mobile content server 120 graphically enriches promotional message 140 by formatting or otherwise combining content of promotional message 140 with the identified graphic, thereby generating graphically enriched promotional message 150. In other words, mobile content server 120 may generate a format different from promotional message 140 using the identified graphic and content of promotional message 140.

In some implementations of the invention, mobile content server 120 prevents advertisers and other promoters from including misleading content such as the text “<<<NEW>>>” in promotional message 140. In these implementations, by preventing advertisers and other promoters from including “<<<NEW>>>” or other misleading content, mobile content server 120 may emphasize the relevance of promotional message 140 using identified graphics such as emoji that convey the substantive content of promotional message 140 rather than content merely intended to draw the recipient's attention. For example, an advertiser may be prevented from inserting “<<<NEW>>>” in an advertisement for a new brand of ramen noodles. Mobile content server 120 may insert an emoji or other graphic representing ramen noodles rather than “<<<NEW>>>” so that the recipient is informed of the relevance of the advertisement instead of merely something that is “NEW.”

In some implementations of the invention, mobile content server 120 may use matcher 126 to generate graphically enriched promotional message 150. In some implementations of the invention, mobile content server 120 is communicably coupled to or includes matcher 126. Matcher 126 may compare the content with match information from match database 128. Match database 128 may include a relational database, a file-based database, or other database that can be used to store and retrieve match information.

In some implementations of the invention, match information includes text, colors, and/or other information that may be matched with the content of promotional message 140. In some implementations of the invention, match information includes match items such as match words assigned with particular graphics such that when content includes words that match one or more particular match words, the graphic assigned to that match word is selected to graphically enrich promotional message 140.

In some implementations of the invention, promotional message 140 may be (but is not limited to) an advertisement that includes content in the form of words that convey promotional message 140. The match information may be (but is not limited to) predefined matching words that are assigned with a graphic. When matched with words in promotional message 140, the graphic assigned with the matching words is selected to graphically enrich promotional message 140. In other words, when promotional message 140 includes the predefined matching words, the graphic assigned with the predefined matching words may be inserted in promotional message 140, thereby generating graphically enriched promotional message 150.

For example, promotional message 140 may include an advertisement that includes the words “buy ringtones.” The word “ringtones” may be a match word that is assigned with, for example, a musical notes graphic. Thus, mobile content server 120 may determine “ringtones” is included in promotional message 140 and accordingly insert the musical notes graphic into promotional message 140. In this example, the musical notes graphic indicates the subject matter (“ringtones”) and therefore relevance of promotional message 140. In this manner, a recipient of graphically enriched promotional message 150 (in this case, the advertisement for ringtones) may quickly ascertain whether the advertisement is relevant to the recipient.

In some implementations of the invention, graphically enriched promotional message 150 may be communicated to mobile communication device 130. Mobile communication device 130 may display graphically enriched promotional message 150 in a web browser, a gaming application interface, or other process that can display graphically enriched promotional message 150 at mobile communication device 130.

According to various implementations of the invention, mobile content server 120 may include a processor 122, a memory 124, and/or other components that facilitate the functions of mobile content server 120 described herein. In some implementations of the invention, processor 122 includes one or more processors configured to perform various functions of mobile content server 120. In some implementations of the invention, memory 124 includes one or more tangible (i.e., non-transitory) and/or transitory computer readable media. Memory 124 may include one or more instructions that when executed by processor 122 configures processor 122 to perform the functions of mobile content server 120.

Although illustrated in FIG. 1 as separate, mobile content server 120 may be included with mobile device 130, promotional message serving system 110, and/or other device that can graphically enrich promotional message 140 as described herein.

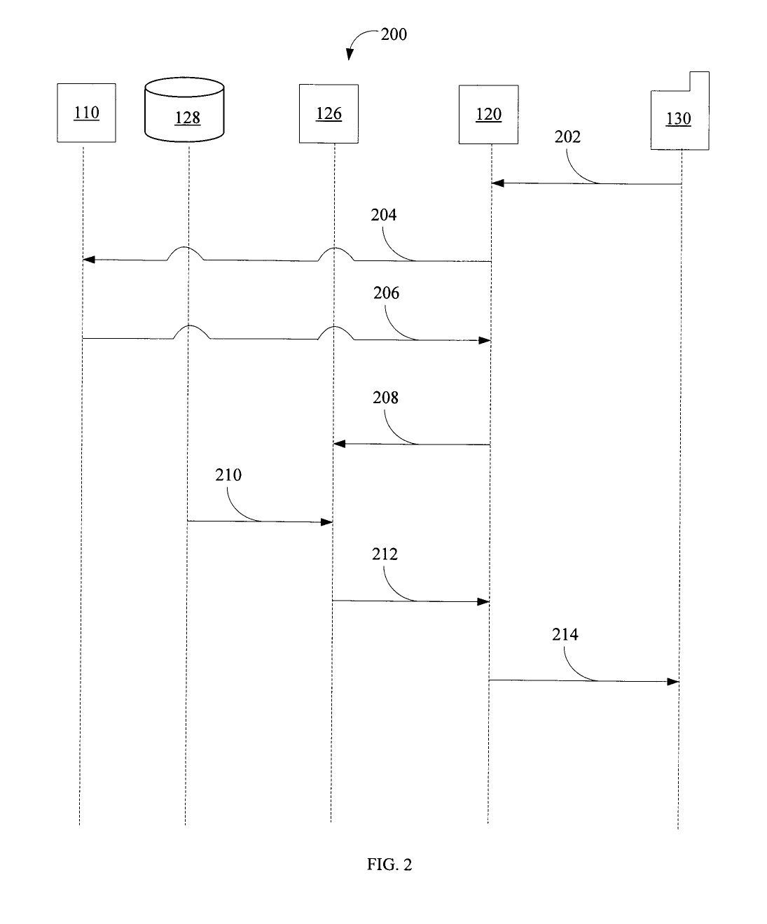

FIG. 2 is a data flow diagram 200 illustrating process relationships in a system 100 for graphically enriching a promotional message 140 to be displayed at a mobile communication device 130, according to various implementations of the invention. The various processing operations and/or data flows depicted in FIG. 2 (and in the other drawing figures) are described in greater detail herein. The described operations for a flow diagram may be accomplished using some or all of the system components described in detail above and, in some implementations of the invention, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

According to various implementations of the invention, in an operation 202, mobile content server 120 may receive a mobile request from mobile communication device 130. The mobile request may be related to an application or other process executing at mobile communication device 130. In some implementations of the invention, the mobile request includes one or more search terms from an operator of mobile communication device 130 entered into a search engine. The search engine may be a web-based search engine and/or a search engine that searches a hard drive or other component of mobile communication device 130. In some implementations of the invention, the mobile request is related to an application such as a gaming or other application being displayed at mobile communication device 130. For example, the mobile request may include a login to an online gaming application accessed using mobile communication device 130. In some implementations of the invention, the mobile request may include location information that indicates a geographic location of mobile communication device 130. Other types of requests related to applications and/or processes executing at mobile communication device 130 may be received by mobile content server 120 as would be appreciated.

In an operation 204, in response to the mobile request, mobile content server 120 may generate a request for a promotional message (such as promotional message 140 illustrated in FIG. 1) to promotional message serving system 110. In some implementations of the invention, the request for a promotional message may include information from the mobile request. Thus, in some implementations of the invention, promotional message serving system 110 may identify an appropriate promotional message to be communicated to mobile communication device 130 based on search terms, gaming application, geographic location, and/or other information included in the mobile request.

In an operation 206, mobile content server 120 may receive a promotional message from promotional message system 110. The promotional message may include content such as text, colors, formatting (such as bold, underline, italics, and other formatting) and/or other information to convey the promotional message. For example, the promotional message may include words such as “buy ringtones,” “cheap airline tickets,” and/or other words or phrases. In another example, the promotional message may include colors such as colored text, colored blocks, or other colored objects. In another example, the promotional message may include bold font words, underlined words, italicized words, and/or other formatted words.

In some implementations of the invention, the received promotional message is typically designed by a promoter, advertiser, or other entity wishing to promote goods and/or services. The promoter typically then uploads the promotional message to promotional message system 110 for storage and retrieval. Because the promoter intends to draw attention to the promotional message instead of conveying a relevance of the promotional message, a recipient of the promotional message may be unable to ascertain the relevance of the promotional message. In other words, the recipient such as an operator of mobile communication device 130 may not quickly ascertain whether the operator is interested in the promotional message. Thus, in some implementations of the invention, mobile content server 120 may perform one or more processes in order to graphically enrich the promotional message in order to convey the relevance of the promotional message to the recipient.

In an operation 208, mobile content server 120 may parse the promotional message to determine its content. By determining the content of the promotional message, an appropriate graphic (or more than one graphic) may be identified that conveys the relevance of the content. For example, mobile content server 120 may identify words, colors, and/or other content included in the promotional message or otherwise determine the content of the promotional message. In some implementations of the invention, mobile content server 120 may communicate the parsed content to matcher 126 in operation 208. As would be appreciated, mobile content server 120 may communicate the promotional message to matcher 126, where the promotional message may be parsed to determine its content.

In an operation 210, matcher 126 may retrieve a match list from match database 128. Match list may include match items such as words, colors, and/or other information that may be matched or otherwise compared to the parsed content. For example, match items may include one or more match words such as “buy,” “ringtone,” “travel,” “airline,” “blue,” “red,” and/or other information that may be compared to the parsed content. In some implementations of the invention, each match item may include more than one word such as “buy ringtone” or other combination of words.

In an operation 212, matcher 126 may compare the match list with the parsed content. In some implementations of the invention, matcher 126 may identify a graphic based on the comparison. In some implementations of the invention, one or more match items of the match list may be assigned to or otherwise associated with a graphic. For example, a match item such as a match word “buy” may be associated with a currency graphic (such as a Yen symbol, a dollar sign symbol, or other currency graphics); a match item such as a match word “travel” may be associated with an airplane graphic; and a match item such as a match color yellow may be associated with a sun graphic. Other examples associations between match items and graphics may be used as would be appreciated. In these implementations, when the parsed content matches a match list item, the graphic assigned to the match list item may be identified. For example, when the parsed content includes the words “buy cheap airline tickets” the currency graphic and/or the airplane graphic may be identified. In operation 212, matcher 126 may communicate the identified graphic or graphics to mobile content server 120.

In an operation 214, mobile content server 120 may graphically enrich the promotional message with the received graphic. In other words, mobile content server 120 may generate a graphically enriched promotional message using the received graphic. In some implementations of the invention, mobile content server 120 may graphically enrich the promotional message by inserting the graphic into the promotional message. For example, mobile content server 120 may insert the graphic at the beginning, in the middle, at the end, or in any other location of the promotional message. In some implementations of the invention, mobile content server 120 may communicate the graphically enriched promotional message to mobile communication device 130.

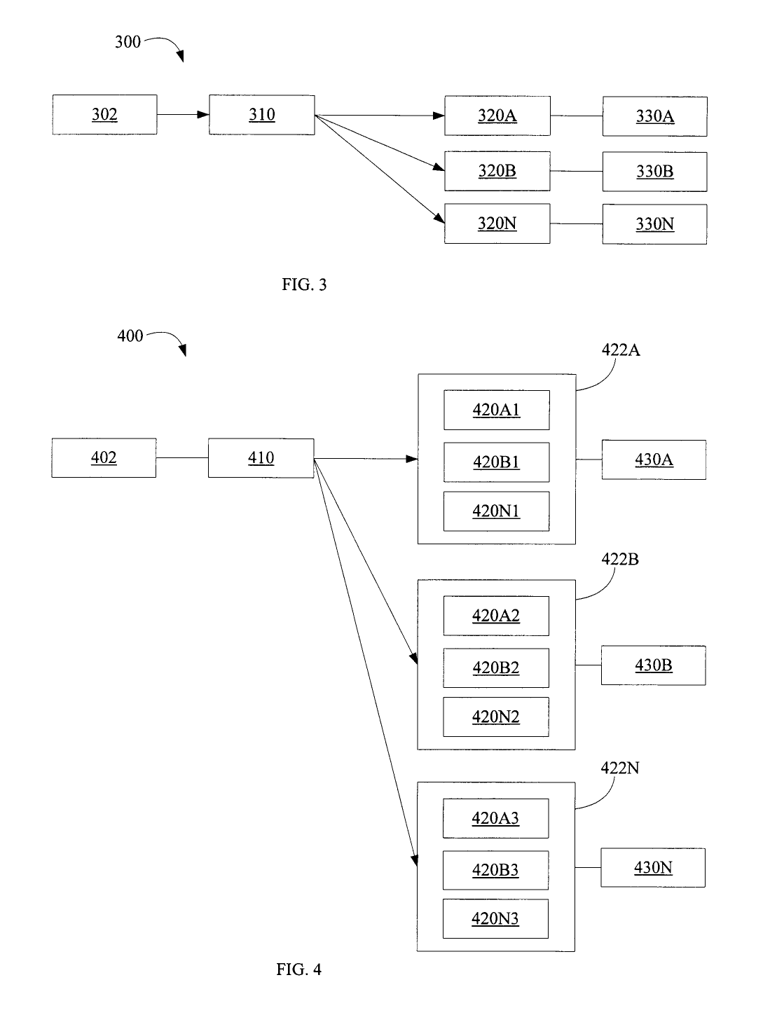

FIG. 3 is a block diagram illustrating a process 300 of identifying a graphic 330 based on match items 320 and content 310 parsed from a promotional message 302, according to various implementations of the invention. In some implementations of the invention, process 300 may be performed by one or more subsystems, such as mobile content server 120, matcher 126, and/or other component, in order to identify a graphic 330 that is used to graphically enrich a promotional message so that the relevance of the promotional message may be determined by a recipient of the graphically enriched promotional message.

According to various implementations of the invention, process 300 may identify a graphic 330 (illustrated in FIG. 3 as graphic 330A, 330B, 330N) by matching content (illustrated in FIG. 3 as content 310) parsed from promotional message 302 with a match item 320 (illustrated in FIG. 3 as match item 320A, 320B, 320N) of a match list.

In some implementations of the invention, each match item 320 may be assigned or otherwise associated with a corresponding graphic 330. Graphic 330 may include, but is not limited to, a video, a bitmap, a vector image, a standardized image such as standardized icons, and/or other graphical object. In some implementations of the invention, graphic 330 may be stored in a memory, such as memory 124 or match database 128, as an image file that includes instructions for generating graphic 330 (such as a JPEG file or other graphical image or images), links to an image file, an encoding, and/or other file or instructions that can be used to generate graphic 330.

In some implementations of the invention, graphic 330 is an emoji or other standardized icon, symbol, or character. The emoji may be generally standardized across different mobile carriers that each include substantially the same set of emoji in their mobile communication devices. In other words, a set of emoji may be predefined at mobile communication device 130 irrespective of the mobile carrier that services the device. For example, each mobile communication device may store (at a memory of the handset), emoji encodings that when executed cause an associated emoji to be displayed at the handset. In some implementations, “graphically enriching” a promotional message with an emoji may include inserting or otherwise including one or more encodings corresponding to the emoji in the promotional message to generate a promotional message that is graphically enriched with the emoji.

When an emoji encoding is received, mobile communication device 130 may display the corresponding emoji. Thus, when promotional message is graphically enriched with an emoji encoding, for example, the mobile communication device may display the promotional message with the corresponding emoji. Because of this general standardization, emoji may be well understood and easily recognized by operators of mobile communication device 130.

In some implementations of the invention, when content 310 matches a particular match item 320, process 300 may identify graphic 330 associated with the particular match item 320. In some implementations of the invention, the identified graphic 330 may be used to graphically enrich promotional message 302.

In some implementations of the invention, process 300 may be performed by matching content 310 with all or a portion of match items 320A, 320B, and 310N. In some implementations of the invention, this process may continue until a maximum number of matches is accumulated, which results in a corresponding number of identified graphics 330. For example, the maximum number of matches may be set to one so that only one graphic 330 is identified and used to enrich promotional message 302. In other examples, the number of matches may be limited to two so that two graphics 330 associated are identified and used to enrich promotional message 302. Other maximum numbers of matches may be used as would be appreciated.

In some implementations of the invention, process 300 matches content 310 in a particular order of match items 320 and stops matching when the maximum number of matches is accumulated. For example, when the maximum number of matches is one, only the first matching match item 320 (and its corresponding graphic 330) may be selected.

In some implementations of the invention, match items 320 may be ordered according to a particular order. In these implementations, process 300 may perform the matching process in the particular order of match items 320 and stop matching when the maximum number of matches is accumulated. For example, when the maximum number of matches is one and match item 320A is earlier in the particular order than match item 320B, match item 320A may be selected when matched even if match item 320B also matches content 310. In this manner, match items 320 may be ordered to achieve priority among matching so that match items 320 that are earlier in the particular order are accorded priority over match items 320 that are later in the particular order.

In some implementations of the invention, match items 320 are ordered by specificity. In these implementations, process 300 may perform the comparing/matching according to the order of match items 320. “Ordered by specificity” refers to one match being more specific than another match item. For example, match item 320A may be a word such as “car” while match item 320B may be a word such as “transportation.” In this example, “car” is more specific than “transportation.” In another example, match item 320A may be a more specific color such as “pale blue” while match item 320B may be a less specific color such as “blue.” Thus, match item 320A may be earlier in the particular order than match item 320B based on a specificity. In these implementations, a graphic 330 associated with “car” may be selected over a graphic 330 associated with “transportation” even if both “car” and “transportation” matches content 310 (i.e., when promotional message 302 includes the words “car” and “transportation”).

In some implementations of the invention, process 300 attempts to match content 310 with all match items 320 and scores each potential match. The match scores may be performed according to known techniques, such as the completeness of the match between content 310 and match item 320, location in content 310 of match items 320, and/or other known scoring techniques. In these implementations, process 300 may select matches having the top scores up to the maximum number of matches. For example, if the maximum number of matches is one, only the top scoring match item 320 (and its corresponding graphic 330) may be selected. In some implementations of the invention, different match items 320 may be accorded different match weights. For example, match item 320A may be associated with a higher match weight than match item 320B. In these implementations, match scores may be adjusted according to the match weight. Thus, even though a match score for match item 320A is lower than the match score for match item 320B, the weighted match score for match item 320A may be higher than the weighted match sore for match item 320B.

In some implementations of the invention, matcher 126 may employ one or more text matching algorithms to compare content 310 with match items 320 in order to identify an appropriate graphic. For example, content 310 may include the words “free ringtone,” match item 320A may include the word “ringtone” associated with a musical notes graphic, and match item 320B may include the word “free” associated with a graphic conveying “FREE.” Process 300 may determine a match between content 310 and each of match items 320A and 320B. However, the “ringtone” match item may be assigned with a higher weight or a higher priority ordering than the “free” match item. Therefore, in this example, the musical notes graphic may be selected over the “FREE” graphic (even though both are associated with match items that match content 310) because the musical notes graphic more accurately conveys the subject matter of the promotional message than the FREE graphic. In this manner, even though an advertiser or other promoter may prefer to emphasize “FREE” rather than the ringtone merely to gain the attention of the recipient, process 300 may select a more appropriate graphic that better conveys the relevance of promotional message 302 to the recipient.

In some implementations of the invention, match item 320 may be associated with a skip item (not illustrated in FIG. 3). Process 300 may compare content 310 with each skip item along with match items 320. When process 300 matches content 310 and a skip item, process 300 may skip the corresponding match item 320. In other words, process 300 may not attempt to match the skipped match item 320 or may disregard a match between content 310 and match item 320 having a corresponding matching skip item. For example, match item 320A may include the text “0Yen,” which is associated with a graphic that conveys “FREE.” In this example, match item 320A may also be associated with a skip item “00Yen” so that when process 300 matches the text “3000Yen” with skip item “00Yen” then match item 320A “0Yen” is skipped. This avoids matching “3000Yen” with “0Yen.” In this manner, a skip item may provide a negative match that causes a match item 320 to be skipped.

In some implementations of the invention, the skip item may include a negative weight associated with the skip item. Thus, in implementations that generate match scores for match items 320, a negative weight may be applied to the match score according to the negative weight associated with the skip item.

FIG. 4 is a block diagram illustrating a process 400 of identifying a graphic 430 based on match classes 422 and content 410 parsed from a promotional message 402, according to various implementations of the invention. According to various implementations of the invention, process 400 may identify a graphic 430 (illustrated in FIG. 4 as graphic 430A, 430B, 430N) by matching content 410 parsed from promotional message 402 with a match class 422 (illustrated in FIG. 4 as match class 422A, 422B, 422N) of a match list.

In some implementations of the invention, each match class 422 may be assigned or otherwise associated with a corresponding graphic 430. Graphic 430 may include graphics as described above with respect to graphic 330.

Each match class may include match items 420 (illustrated in FIG. 4 as match items 420A1, 420B1, 420N1, 420A2, 420B2, 420N2, 420A3, 420B3, and 420N3). Match items 420 may be analogous to match items 320 illustrated in FIG. 3, except match items 420 are classified into match classes 422. For example, the words “car,” “airplane,” and “train” may be classified into a class “transportation.” Thus, when promotional message 402 includes any of these words, process 400 may determine a match between the “transportation” class and content 410 then identify a graphic 430 assigned with the “transportation” class to graphically enrich promotional message 402. In another example, the colors “light blue,” “dark blue,” and “blue” may be classified into a class “blue.” Other types of classifications may be used as would be appreciated.

In some implementations of the invention, process 400 may determine a match between match class 422 and content 410 in an “all-or-none” fashion. In these implementations, all match items 420 in match class 422 must match in order for the match class 422 to be identified as a match. In some implementations of the invention, process 400 may determine a match between match class 422 and content 410 based on a single match with a match item 420 within match class 422 and content 410. In some implementations of the invention, process 400 may determine a match between match class 422 based on an overall match score for the match class. In these implementations, the overall match score may be determined based on a cumulative sum of match scores for match items 420 within match class 422.

In some implementations of the invention, the process 400 may perform similar matching/comparing functions as process 300 illustrated in FIG. 3. For example, each match class 422 may be ordered, weighted, be associated with skip items, and/or be processed as described with respect to FIG. 3. Furthermore, each match item 420 within a match class 422 may be weighted to contribute to the overall match score for a particular match class 422.

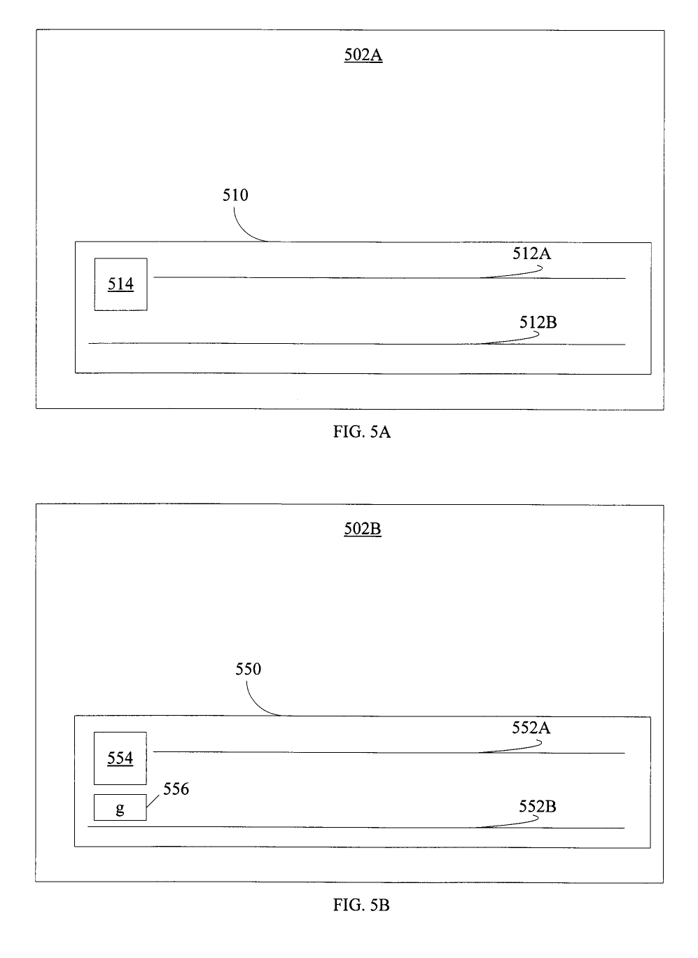

FIGS. 5A and 5B are diagrams illustrating graphically enriched promotional messages as displayed on a display screen 502, according to various implementations of the invention. Display screen 502 (illustrated in FIGS. 5A and 5B as display screen 502A and 502B) may be part of mobile communication device 130 or other device that can house display screen 502.

Referring to FIG. 5A, graphically enriched promotional message 510 may include content 512 (illustrated as lines 512A and 512B) parsed from a promotional message that was not graphically enriched. Content 512 may include all or some of the words, colors, and/or other content included in a promotional message prior to graphical enrichment, such as promotional message 140. For example, content 512 may include words such as “buy ringtones” to advertise ringtones for sale. As previously described, a graphic may be identified based on content from a promotional message. The identified graphic (illustrated in FIG. 5A as graphic 514) is included in graphically enriched promotional message 510. For example, graphic 514 may include (but is not limited to) a musical notes graphic that indicates the relevance of the “buy ringtones” content. In some implementations of the invention, graphic 514 may be positioned at a conspicuous location with respect to content 512, such as near the beginning (or particular corner) of content 512. In this manner, a recipient of graphically enriched promotional message 510 may quickly ascertain the relevance of graphically enriched promotional message 510 using graphic 514.

As would be appreciated, graphic 514 may be positioned at any location within graphically enriched promotional message 510, such as in the middle of content 512, at the end of content 512, and/or other locations with respect to content 512. Furthermore, although illustrated as a single graphic, more than one graphic 514 may be included in graphically enriched promotional message 510.

Referring to FIG. 5B, graphically enriched promotional message 550 may include content 552 (illustrated as lines 552A and 552B) parsed from a promotional message that was not graphically enriched. Content 552 may be similar to content 512 described above with respect to FIG. 5A. In some implementations of the invention, graphically enriched promotional message 550 includes graphic 554, which is identified based on content 552. In some implementations graphic 554 includes an identifier 556 (illustrated in FIG. 5B as the letter “g”) that identifies a source of graphic 554. In other words, identifier 556 may enable the recipient to identify the entity that included graphic 554. For example, identifier 556 may be used to distinguish graphics placed by advertisers when designing a promotional message from graphics placed by advertising serving entities that place graphics (via mobile content server 120, for example) into promotional messages so that the recipient may determine the relevance of graphically enriched promotional message 550. In this manner, the identifier may be used to indicate that the graphic may be used to determine relevance of a message rather than a graphic designed by an advertiser to merely draw attention to the message.

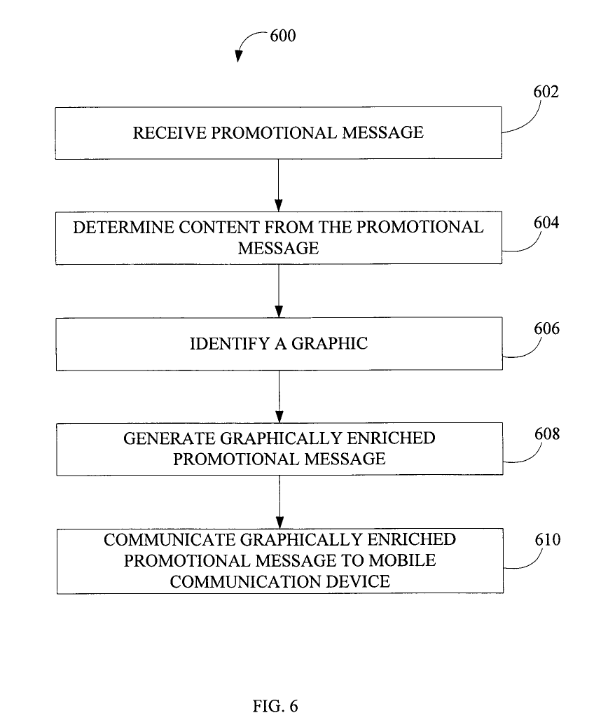

FIG. 6 is a process diagram illustrating a process 600 of graphically enriching a promotional message to be displayed at a mobile communication device, according to various implementations of the invention.

In an operation 602, process 600 may receive a promotional message. The promotional message may be received from a promotional message serving system that serves promotional messages such as advertisements to be displayed to recipients. The promotional message as received is designed by an advertiser or other promoter wishing to sell goods and/or services. Thus, the promotional message is typically designed to attract attention rather than to convey relevance to a recipient.

In an operation 604, process 600 may determine content from the promotional message. For example, the promotional message may be parsed to identify text, words, colors, or other content included in the promotional message. The content may include, for example, “buy one ball of yarn, get one free” and/or other content that conveys the promotional message. In this example, the advertiser may wish to emphasis “free” merely to capture the attention of the recipient without conveying the relevance of the promotional message (e.g., the recipient may not be interested in yarn).

In an operation 606, process 600 may identify a graphic based on the determined content. Process 600 may generate a match between the words and match words that are associated with particular graphics. Thus, an associated graphic for a particular match may be identified. For example, process 600 may identify a graphic associated with knitting supplies to thereby convey the relevance of the promotional message related to the yarn example above.

In an operation 608, process 600 may generate a graphically enriched promotional message. For example, process 600 may combine the determined content with the identified graphic.

In an operation 610, process 600 may communicate the graphically enriched promotional message to a mobile communication device. In this manner, the recipient of the graphically enriched promotional message, such as an operator of the mobile communication device, may receive graphics identified by process 600 that convey relevance rather than graphics that are designed/selected by advertisers to capture attention. In the foregoing example, the recipient may not be interested in knitting supplies. Thus, by enriching the promotional message with a knitting supply graphic, for example, the recipient is able to quickly ascertain that the graphically enriched promotional message is not relevant to the recipient.

Although described herein as communicating the graphically enriched promotional message to a mobile communication device, the graphically enriched promotional message may be communicated to a third party such as a publisher of promotional messages or other entity as would be appreciated. For example, the graphically enriched promotional message may be generated and communicated to a party or other entity that may be responsible for communicating the message to the mobile communication device. Therefore, in some implementations of the invention, mobile content server 120, for example, may communicate the graphically enriched promotional message for display. In these implementations, the party or other entity receiving the graphically enriched promotional message may communicate the message to the mobile communication device or other device that can display the message.

Implementations of the invention may be made in hardware, firmware, software, or any suitable combination thereof. Implementations of the invention may also be implemented as instructions stored on a machine readable medium, which may be read and executed by one or more processors. A tangible machine-readable medium may include any tangible, non-transitory, mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Intangible machine-readable transmission media may include intangible forms of propagated signals, such as carrier waves, infrared signals, digital signals, and other intangible transmission media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A method of graphically enriching a promotional message delivered to a mobile communication device, comprising:
receiving, by one or more processors of a mobile content server, the promotional message to be delivered to the mobile communication device, wherein the promotional message includes content that conveys the promotional message;
determining, by the mobile content server, the content included in the received promotional message;
identifying, by the mobile content server, at least one graphic associated with the determined content, wherein the at least one graphic conveys a relevance of the promotional message;
generating, by the mobile content server, a graphically-enriched promotional message that includes the determined content and the identified at least one graphic; and
communicating, by the mobile content server, the graphically-enriched promotional message for display.

2. The method of claim 1, wherein the received content includes at least one of:
one or more words or one or more colors.

3. The method of claim 1, wherein the content includes at least one word that conveys the promotional message, and wherein said identifying further comprises:
comparing, by the mobile content server, the at least one word to a plurality of one or more match words, wherein each one of the plurality of one or more match words is assigned with a corresponding graphic; and
determining, by the mobile content server, a match between the at least one word and at least one of the plurality of one or more match words, wherein the identified at least one graphic is based at least in part on the determined match.

4. The method of claim 3, wherein the plurality of one or more match words is ordered by specificity, and wherein said comparing is performed according to the order of the plurality of one or more match words.

5. The method of claim 3, wherein a particular one of the plurality of one or more match words is associated with a skip word, the method further comprising:
determining, by the mobile content server, a skip word match between the skip word and the at least one word; and
skipping, by the mobile content server, the particular one of the plurality of one or more match words associated with the skip word based on the skip word match.

6. The method of claim 1, wherein the at least one graphic is an emoji.

7. The method of claim 6, wherein the emoji graphic is one among a plurality of emojis predefined at the mobile communication device.

8. A system of graphically enriching a promotional message delivered to a mobile communication device, comprising:
a mobile content server comprising one or more processors configured to:
receive the promotional message to be delivered to the mobile communication device, wherein the promotional message includes content that conveys the promotional message;
determine the content included in the received promotional message;
identify at least one graphic associated with the determined content, wherein the at least one graphic conveys a subject matter of the promotional message;
generate a graphically-enriched promotional message that includes the determined content and the identified at least one graphic; and
communicate the graphically-enriched promotional message for display.

9. The system of claim 8, wherein the received content includes at least one of:
one or more words or one or more colors.

10. The system of claim 8, wherein the content includes at least one word that conveys the promotional message, and wherein the mobile content server is further configured to:
compare the at least one word to a plurality of one or more match words, wherein each one of the plurality of one or more match words is assigned with a corresponding graphic; and
determine a match between the at least one word and at least one of the plurality of one or more match words, wherein the identified at least one graphic is based at least in part on the determined match.

11. The system of claim 10, wherein the plurality of one or more match words is ordered by specificity, wherein said comparison is performed according to the order of the plurality of one or more match words.

12. The system of claim 10, wherein a particular one of the plurality of one or more match words is associated with a skip word, and wherein the mobile content server is further configured to:
determine a skip word match between the skip word and the at least one word; and
skip the particular one of the plurality of one or more match words associated with the skip word based on the skip word match.

13. The system of claim 8, wherein the at least one graphic is an emoji.

14. The system of claim 13, wherein the emoji graphic is one among a plurality of emojis predefined at the mobile communication device.

15. A method of graphically enriching a promotional message delivered to a mobile communication device, comprising:
receiving, by one or more processors of a mobile content server, the promotional message to be delivered to the mobile communication device, wherein the promotional message includes content that conveys the promotional message;
determining, by the mobile content server, the content included in the received promotional message;
identifying, by the mobile content server, an emoji associated with the determined content, wherein the emoji conveys a relevance of the promotional message;
generating, by the mobile content server, a graphically-enriched promotional message that includes the determined content and the identified emoji; and
communicating, by the mobile content server, the graphically-enriched promotional message for display.

16. The method of claim 15, wherein the received content includes at least one of:
one or more words or one or more colors.

17. The method of claim 15, wherein the content includes at least one word that conveys the promotional message, and wherein said identifying further comprises:
comparing, by the mobile content server, the at least one word to a plurality of one or more match words, wherein each one of the plurality of one or more match words is assigned with a corresponding emoji; and
determining, by the mobile content server, a match between the at least one word and at least one of the plurality of one or more match words, wherein the identified emoji is based at least in part on the determined match.

18. The method of claim 17, wherein the plurality of one or more match words is ordered by specificity, and wherein said comparing is performed according to the order of the plurality of one or more match words.

19. The method of claim 17, wherein a particular one of the plurality of one or more match words is associated with a skip word, the method further comprising:
determining, by the mobile content server, a skip word match between the skip word and the at least one word; and
skipping, by the mobile content server, the particular one of the plurality of one or more match words associated with the skip word based on the skip word match.

20. The method of claim 15, wherein the identified emoji is one among a plurality of emojis predefined at the mobile communication device.
